(19) United States
(12) Patent Application Publication
(10) Pub. No.: US 2022/0147906 A1
(43) Pub. Date: May 12, 2022

(54) WORK SCHEDULE CREATION SYSTEM AND WORK SCHEDULE CREATION METHOD

(71) Applicant: Mitsubishi Power, Ltd., Yokohama-shi, Kanagawa (JP)

(72) Inventors: Junichi Kuwahara, Yokohama-shi (JP); Satoru Higuchi, Yokohama-shi (JP); Hayato Isakai, Yokohama-shi (JP); Susumu Sekine, Yokohama-shi (JP)

(73) Assignee: Mitsubishi Power, Ltd., Yokohama-shi, Kanagawa (JP)

(21) Appl. No.: 17/431,505

(22) PCT Filed: Feb. 13, 2020
(86) PCT No.: PCT/JP2020/005610

§ 371 Date: Aug. 17, 2021

(30) Foreign Application Priority Data
Apr. 5, 2019 (JP) 2019-072389

(51) Int. Cl. G06Q 10/06; G06F 3/0482

(52) U.S. Cl. CPC G06Q 10/063116; G06F 3/0482

(57) ABSTRACT

A work schedule creation system includes a display control unit configured to be able to execute an improvement measure display mode of displaying items of a plurality of improvement measures capable of improving the works on the display unit, and an improved schedule creation unit configured to create, based on a standard work schedule and shortening effect information indicating a shortening effect of a required period for the works by application of an improvement measure in an item selected by an input unit from among the items of the plurality of improvement measures, an improved work schedule obtained by improving the standard work schedule. The display control unit is configured to be able to execute an improved schedule display mode of displaying the improved work schedule created by the improved schedule creation unit on the display unit.

### TECHNICAL FIELD

The present disclosure relates to a work schedule creation system and a work schedule creation method.

### BACKGROUND

Patent Document 1 discloses a process control system capable of creating and examining a process schedule that predicts a delay in process from result data expressing strengths/weaknesses of a worker with respect to respective work types by using a matrix including the worker and the types of work contents, and considers the delay in process.

### CITATION LIST

### Patent Literature

Patent Document 1: JPH9-259178A

### SUMMARY

### Technical Problem

Meanwhile, regarding a plurality of works performed in inspection of a plant, various improvement measures can exist which are capable of achieving, for example, shortening of a work period relative to standard work.

However, for example, if a consultant proposes the improvement measures for work to a user of the plant, whether it is possible to select appropriate improvement measure considering an influence on a work schedule of the inspection depends on an ability of the person who provides consulting service.

In view of the above, an object of at least one embodiment of the present invention is to provide a work schedule creation system and a work schedule creation method which are capable of supporting selection of, regarding the improvement measures for the work performed in inspection of the plant, the appropriate improvement measure considering the influence on the work schedule.

### Solution to Problem

(1) A work schedule creation system according at least one embodiment of the present invention is a work schedule creation system for creating a work schedule showing a schedule of a plurality of works performed in inspection of a plant, the system including an input unit, a display unit, and a control unit, the control unit including a display control unit configured to be able to execute an improvement measure display mode of displaying items of a plurality of improvement measures capable of improving the works on the display unit, and an improved schedule creation unit configured to create, based on a standard work schedule and shortening effect information indicating a shortening effect of a required period for the works by application of an improvement measure in an item selected by the input unit from among the items of the plurality of improvement measures, an improved work schedule obtained by improving the standard work schedule. The display control unit is configured to be able to execute an improved schedule display mode of displaying the improved work schedule created by the improved schedule creation unit on the display unit.

With the work schedule creation system described in the above configuration (1), a user of the system can visually check the improved work schedule, on which the shortening effect of the required period for the works by application of the improvement measure in the item selected by the input unit is reflected, via the display unit. Thus, it is possible to examine whether to apply the improvement measure while considering an influence of the improvement measure on the work schedule of the inspection. Therefore, it is possible to support selection of the appropriate improvement measure in consideration of the influence on the work schedule of the inspection of the plant.

Furthermore, displaying not only an object such as a jig and tool but also review work, adjustment work, and the like of tolerance relaxation and the like as the improvement measures in the improvement measure display mode, it is possible to comprehensively determine the value of these improvement measures in consideration of the shortening effect of the required period for the inspection.

(2) In some embodiments, in the work schedule creation system described in the above configuration (1), each of the standard work schedule and the improved work schedule includes items of a plurality of work places where the works are performed in the inspection and a work period for each of the work places.

With the work schedule creation system described in the above configuration (2), the user of the system can visually check the influence of the improvement measure on the work period for each work place, making it possible to examine whether to apply the improvement measure while considering the influence of the improvement measure on the work period for each work place.

(3) In some embodiments, in the work schedule creation system described in the above configuration (2), the display control unit is configured to be able to execute a standard schedule display mode of displaying the standard work schedule, and the display control unit is configured to display the items of the plurality of improvement measures on the display unit in the improvement measure display mode, regarding the work place selected by the input unit from among the plurality of work places during execution of the standard schedule display mode.

With the work schedule creation system described in the above configuration (3), the items of the plurality of improvement measures are displayed on the display unit, regarding the work place selected by the input unit. Thus, compared to a case where a consultant is in charge of from extraction to proposal of the improvement measure, the user of the system can completely examine whether to apply the improvement measure for each work place while reducing dependency on the ability of the person.

(4) In some embodiments, in the work schedule creation system described in the above configuration (1) or (2), the display control unit is configured to be able to execute a work category display mode of displaying a plurality of work categories of the works performed in the inspection on the display unit, and the display control unit is configured to display the items of the plurality of improvement measures on the display unit in the improvement measure display mode, regarding the work category selected by the input unit during execution of the work category display mode.

With the work schedule creation system described in the above configuration (4), the items of the plurality of improvement measures are displayed on the display unit, regarding the work category selected by the input unit. Thus, compared to the case where the consultant is in charge of from extraction to proposal of the improvement measure, the user of the system can completely examine whether to apply the improvement measure for each work category while reducing dependency on the ability of the person.

(5) In some embodiments, in the work schedule creation system described in any one of the above configurations (1) to (4), the display control unit is configured to be able to execute an improvement effect display mode of displaying an effect of the improvement measure on the display unit, regarding the item selected by the input unit from among the items of the plurality of improvement measures displayed in the improvement measure display mode.

With the work schedule creation system described in the above configuration (5), since the effect of the improvement measure selected by the input unit is displayed on the display unit, the user of the system can examine whether to apply the improvement measure in consideration of the effect of the improvement measure displayed on the display unit while reducing dependency on knowledge of the consultant or the like about the effect of the improvement measure.

(6) In some embodiments, in the work schedule creation system described in the above configuration (5), the display control unit is configured to be able to display, in addition to the effect of the improvement measure, a moving image showing contents of the improvement measure on the display unit in the improvement effect display mode.

With the work schedule creation system described in the above configuration (6), the user of the system can deepen understanding of the contents of the improvement measure by checking the moving image.

(7) In some embodiments, in the work schedule creation system described in any one of the above configurations (1) to (6), the display control unit is configured to display the improved work schedule created by the improved schedule creation unit and the standard work schedule side by side on the display unit in the improved schedule display mode.

With the work schedule creation system described in the above configuration (7), the standard work schedule and the improved work schedule are displayed side by side on the display unit, making it easier to visually confirm a difference between the standard work schedule and the improved work schedule which is made by application of the improvement measure. Therefore, it is possible to effectively support selection of the appropriate improvement measure in consideration of the influence on the work schedule of the inspection of the plant.

(8) In some embodiments, in the work schedule creation system described in any one of the above configurations (1) to (7), the control unit includes a standard schedule correction unit configured to correct the standard work schedule based on a required period for the inspection input from the input unit and a required period for the inspection in the standard work schedule.

An actual required period for inspection of the plant differs from user to user of the plant and often does not coincide with an initial value of the required period for the inspection in the standard work schedule. In this regard, with the work schedule creation system described in the above configuration (8), correcting the standard work schedule in accordance with the user in consideration of the required period input from the input unit, it is possible to create and display the appropriate improved work schedule suitable for an actual situation of the user based on the corrected standard work schedule. Therefore, it is possible to effectively support selection of the appropriate improvement measure in consideration of the influence on the work schedule of the inspection of the plant.

(9) In some embodiments, in the work schedule creation system described in any one of the above configurations (1) to (8), the display control unit is configured to be able to execute a selected improvement measure display mode of displaying the items of the plurality of improvement measures, as well as highlighting the item of the selected improvement measure selected by the input unit.

With the work schedule creation system described in the above configuration (9), the user of the system can easily grasp the selected improvement measure, making it easier to consider the influence of the selected improvement measures on the work schedule of the inspection, for example, in the case where the plurality of improvement measures are selected. Therefore, it is possible to effectively support selection of the appropriate improvement measure in consideration of the influence on the work schedule of the inspection of the plant.

(10) In some embodiments, in the work schedule creation system described in the above configuration (9), the display control unit is configured to be able to change presence or absence of the highlight with respect to the item of the improvement measure in accordance with an operation of the input unit in the selected improvement measure display mode.

With the work schedule creation system described in the above configuration (10), the user of the system can easily change the selected improvement measure, making it easier to consider the influence of the selected improvement measures on the work schedule of the inspection, for example, in the case where the plurality of improvement measures are selected. Therefore, it is possible to effectively support selection of the appropriate improvement measure in consideration of the influence on the work schedule of the inspection of the plant.

(11) A work schedule creation method according at least one embodiment of the present invention is a work schedule creation method for creating a work schedule showing a schedule of a plurality of works performed in inspection of a plant, the method including a step of displaying items of a plurality of improvement measures capable of improving the works on a display unit, a step of creating, based on a standard work schedule and shortening effect information indicating a shortening effect of a required period for the works by introduction of an improvement measure of an item selected by an input unit from among the items of the plurality of improvement measures, an improved work schedule obtained by improving the standard work schedule, and a step of displaying the improved work schedule on the display unit.

With the work schedule creation method described in the above method (11), it is possible to visually check the improved work schedule, on which the shortening effect of the required period for the works by application of the improvement measure in the item selected by the input unit is reflected, via the display unit. Thus, it is possible to examine whether to apply the improvement measure while considering an influence of the improvement measure on the work schedule of the inspection. Therefore, it is possible to support selection of the appropriate improvement measure in consideration of the influence on the work schedule of the inspection of the plant.

### Advantageous Effects

According to at least one embodiment of the present invention, provided are a work schedule creation system and a work schedule creation method which are capable of supporting selection of an appropriate improvement measure considering an influence on a work schedule regarding improvement measures for work performed in inspection of a plant.

### BRIEF DESCRIPTION OF DRAWINGS

FIG. 1 is a block diagram showing a schematic hardware configuration of a portable information terminal 2 according to an embodiment of the present invention.

FIG. 2 is a block diagram showing a functional schematic configuration of a control unit 8 shown in FIG. 1.

FIG. 3 is a diagram schematically showing a part of a database structure in a ROM or an HDD of a storage unit 10.

FIG. 4 is a diagram schematically showing a part of the database structure in the ROM or the HDD of the storage unit 10.

FIG. 5 is a flowchart showing a part of a creation flow of a work schedule by the control unit 8 according to an embodiment.

FIG. 6 is a flowchart showing the rest of the creation flow of the work schedule shown in FIG. 5.

FIG. 7 is a flowchart showing the rest of the creation flow of the work schedule shown in FIG. 5.

FIG. 8 is a view showing an example of a display screen (initial input screen P1) of a display unit 4 in an initial input screen display mode.

FIG. 9 is a view showing an example of a display screen (work schedule creation menu P2) of the display unit 4 in a standard schedule display mode.

FIG. 10 is a view showing an example of a display screen (improvement measure item menu P3) of the display unit 4 in an improvement measure by work place display mode.

FIG. 11 is a view showing an example of a display screen P4 of the display unit 4 in an improvement effect display mode.

FIG. 12 is a view showing an example of a display screen P5 of the display unit 4 in a selected improvement measure display mode.

FIG. 13 is a view showing an example of a display screen P6 of the display unit 4 in an improved schedule display mode.

FIG. 14 is a view showing an example of a display screen P7 of the display unit 4 in a work category display mode.

FIG. 15 is a view showing an example of a display screen (improvement measure item menu P8) of the display unit 4 in an improvement measure by work category display mode.

### DETAILED DESCRIPTION

Some embodiments of the present invention will be described below with reference to the accompanying drawings. It is intended, however, that unless particularly identified, dimensions, materials, shapes, relative positions and the like of components described or shown in the drawings as the embodiments shall be interpreted as illustrative only and not intended to limit the scope of the present invention.

For instance, an expression of relative or absolute arrangement such a “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same”, “equal”, and “uniform” shall not be construed as indicating only the state in which the feature is strictly equal, but also includes a state in which there is a tolerance or a difference that can still achieve the same function.

Further, for instance, an expression of a shape such as a rectangular shape or a tubular shape shall not be construed as only the geometrically strict shape, but also includes a shape with unevenness or chamfered corners within the range in which the same effect can be achieved.

On the other hand, the expressions “comprising”, “including”, “having”, “containing”, and “constituting” one constituent component are not exclusive expressions that exclude the presence of other constituent components.

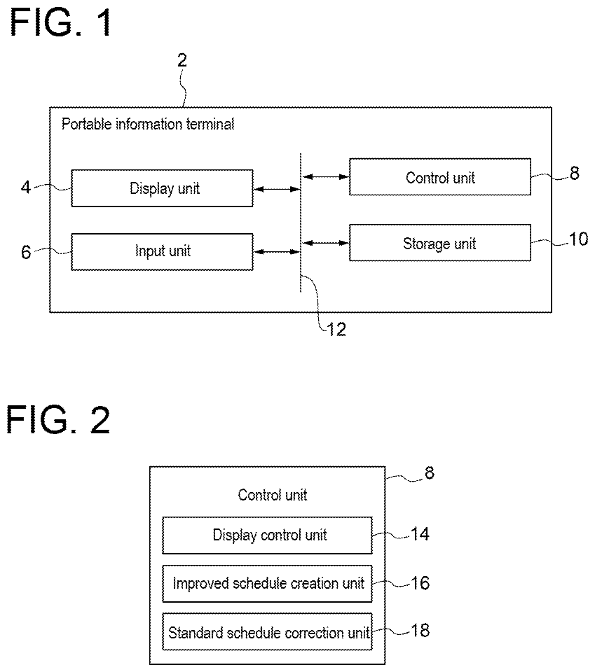

FIG. 1 is a block diagram showing a schematic hardware configuration of a portable information terminal 2 according to an embodiment of the present invention. The portable information terminal 2 configures a work schedule creation system for creating a work schedule (process schedule) showing a schedule of a plurality of works (work processes) performed in periodic inspection of a plant. Although the type of plant is not particularly limited, a description will be given below by taking a work schedule of periodic inspection of a gas turbine plant as an example.

As the portable information terminal 2, for example, a tablet terminal or a smart phone is exemplified. The portable information terminal 2 includes a display unit 4, an input unit 6, a control unit 8, and a storage unit 10, and these hardware devices are communicably connected to each other via a bus 12.

The display unit 4 is constituted by, for example, a liquid crystal display or an organic EL display.

The input unit 6 is constituted by, for example, a touch sensor disposed on a screen of the display unit. In this case, a touch panel including the touch sensor constitutes the display unit 4 and the input unit 6. The portable information terminal 2 will be described below by taking a case where the display unit 4 and the input unit 6 are constituted by the touch panel as an example.

The control unit 8 is a computation device for loading programs and data from the storage unit 10 to perform a process, and is constituted by, for example, a CPU.

The storage unit 10 includes, for example, a random access memory (RAM), a read only memory (ROM), a hard disk drive (HDD), and the like. The storage unit 10 stores programs for executing various kinds of control processing, various kinds of data, and the like.

FIG. 2 is a block diagram showing a functional schematic configuration of the control unit 8 shown in FIG. 1.

As shown in FIG. 2, the control unit 8 includes a display control unit 14, an improved schedule creation unit 16, and a standard schedule correction unit 18.

As will be described later, the display control unit 14 is configured to be able to execute an initial input screen display mode, a standard schedule display mode, a work category display mode, an improvement measure by work place display mode, an improvement measure by work category display mode, an improved schedule display mode, an improvement effect display mode, a selected improvement measure display mode, and an all improvement measures display mode.

As will be described later, the improved schedule creation unit 16 is configured to create an improved schedule obtained by improving a standard work schedule.

As will be described later, the standard schedule correction unit 18 is configured to perform correction of compressing or decompressing the standard work schedule based on a required period for periodic inspection of the plant input by the input unit 6 and a required period for the periodic inspection in the standard work schedule.

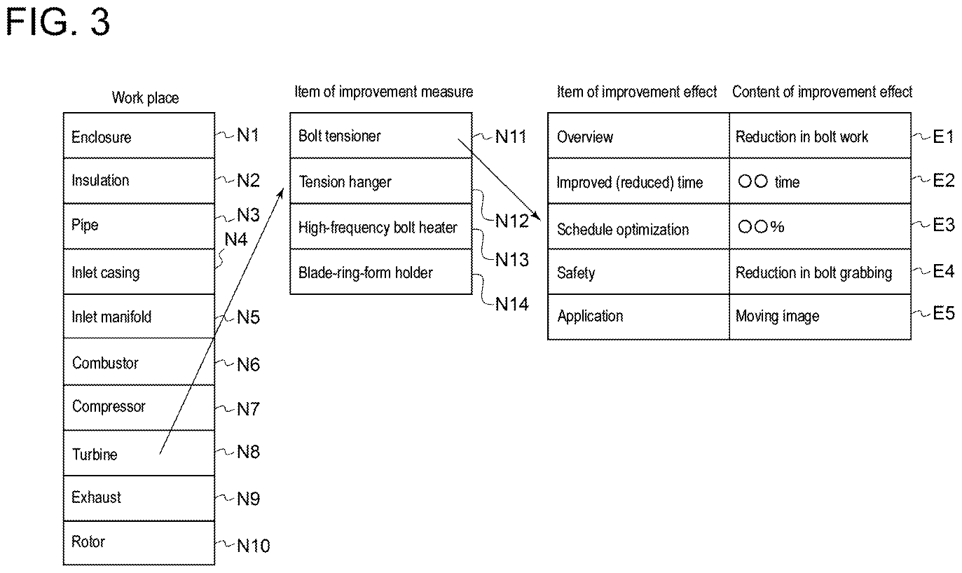

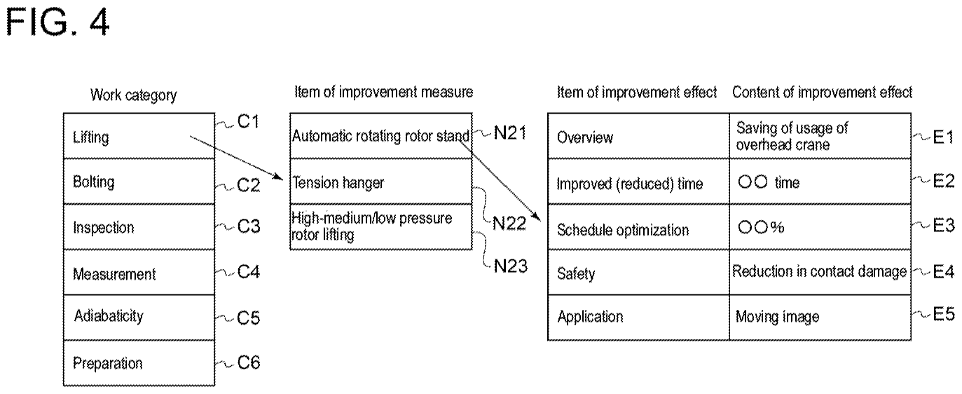

Each of FIGS. 3 and 4 is a diagram schematically showing apart of a database structure in the ROM or the HDD of the storage unit 10. As shown in at least one of FIGS. 3 and 4, the storage unit 10 stores items N1 to N10 of a plurality of work places where work is performed in periodic inspection of the plant, items C1 to C6 of a plurality of work categories of the work performed in periodic inspection of the plant, items (N1 to N14, N21 to N23, and the like) of a plurality of improvement measures capable of improving the work performed in periodic inspection of the plant, and a plurality of improvement effects (E1 to E4 and the like) by the respective improvement measures. Each of the improvement effects E1 to E4 is formed by a combination of the item of the improvement effect and a content of the improvement effect.

As shown in FIG. 3, the items N1 to N10 of the work places are associated with the items (N11 to N14 or other items) of the plurality of improvement measures, respectively. As shown in FIG. 4, the items CI to C6 of the work categories are associated with the items (N21 to N23 or other items) of the plurality of improvement measures, respectively. Moreover, as shown in FIGS. 3 and 4, the items (N1 to N14, N21 to N23, and the like) of the improvement measures are associated with the plurality of improvement effects (E1 to E4 and the like), respectively.

In a part of the data structure illustrated in FIG. 3, as the items N1 to N10 of the work places, an enclosure, an insulation, a pipe, an inlet casing, an inlet manifold, a combustor, a compressor, a turbine, an exhaust, and a rotor are shown, respectively. Further, as the items N11 to N14 of the improvement measures capable of improving the work performed in inspection of the item N8 of the turbine, a bolt tensioner, a tension hanger, a high-frequency bolt heater, a blade-ring-form holder are shown, respectively. Furthermore, as the improvement effects by application of the bolt tensioner, the overview E1 of the effect of the improvement measure, the shortening effect E2 of the required period for work (for example, a reduced time, that is, an improved time of work by the improvement measure), the percentage E3 of schedule optimization, the improvement effect E4 of safety, and the like are shown, respectively.

Moreover, in a part of the data structure illustrated in FIG. 4, as the work categories C1 to C6, lifting, bolting, inspection, measurement, adiabaticity, and preparation are shown, respectively. Further, as the items N21 to N23 of the improvement measures capable of improving lifting work, an automatic rotating rotor stand, the tension hanger, and a high-medium/low pressure rotor lifting are shown, respectively. Furthermore, as the improvement effects by application of the automatic rotating rotor stand, the overview E1 of the effect of the improvement measure, the shortening effect E2 of the required period for work (for example, a reduced time, that is, an improved time of work by the improvement measure), the percentage E3 of schedule optimization, the improvement effect E4 of safety, and the like are shown, respectively.

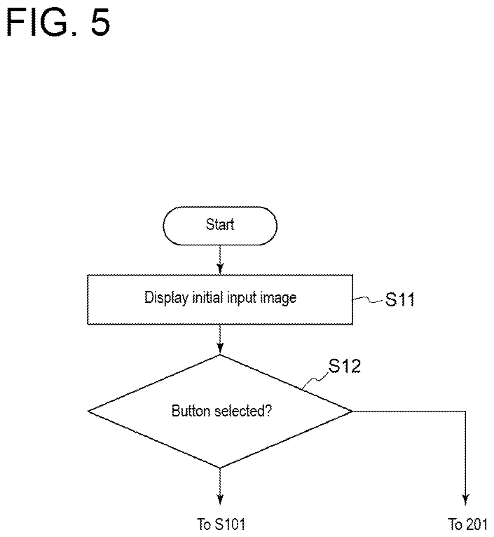

Hereinafter, detailed functions of the above-described display control unit 14, improved schedule creation unit 16, and standard schedule correction unit 18 will be described with reference to FIG. 5 to FIG. 15, respectively.

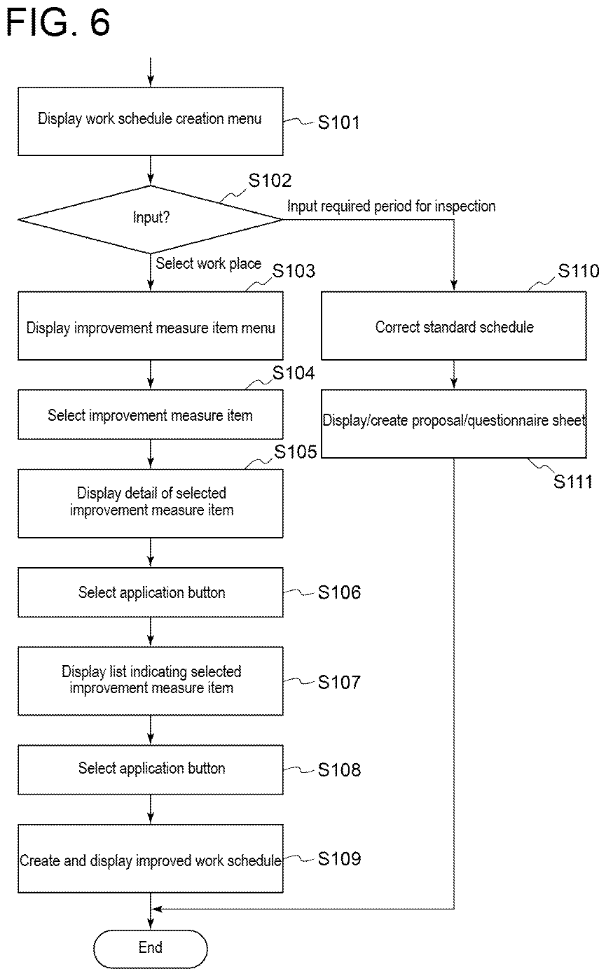

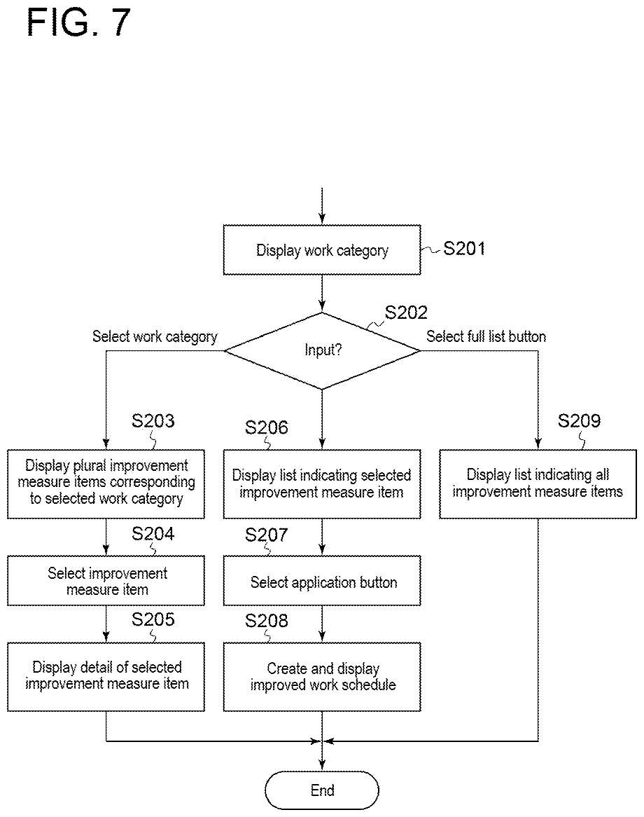

FIG. 5 is a flowchart showing a part of a creation flow of the work schedule by the control unit 8 according to an embodiment. FIG. 6 is a flowchart showing the rest of the creation flow of the work schedule shown in FIG. 5. FIG. 7 is a flowchart showing the rest of the creation flow of the work schedule shown in FIG. 5.

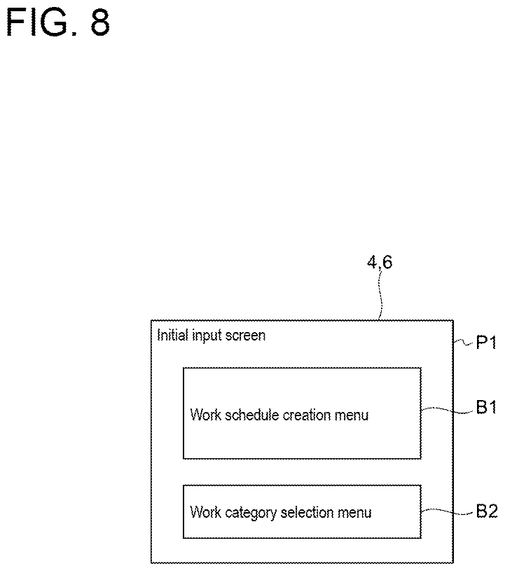

As shown in FIG. 5, in S11, the display control unit 14 executes the initial input screen display mode of displaying an initial input screen P1 (see FIG. 8) on the display unit 4. On the initial input screen P1, a button BI for a work schedule creation menu and a button B2 for a work category selection menu are displayed. One of these two buttons can be selected by a user via the input unit 6.

Next, in S12, it is determined whether one of the button BI for the work schedule creation menu and the button B2 for the work category selection menu is selected in S11. If the button BI for the work schedule creation menu is selected in S11, the process moves to S101 of FIG. 6. If the button B2 for the work category selection menu is selected in S11, the process moves to S201 of FIG. 7.

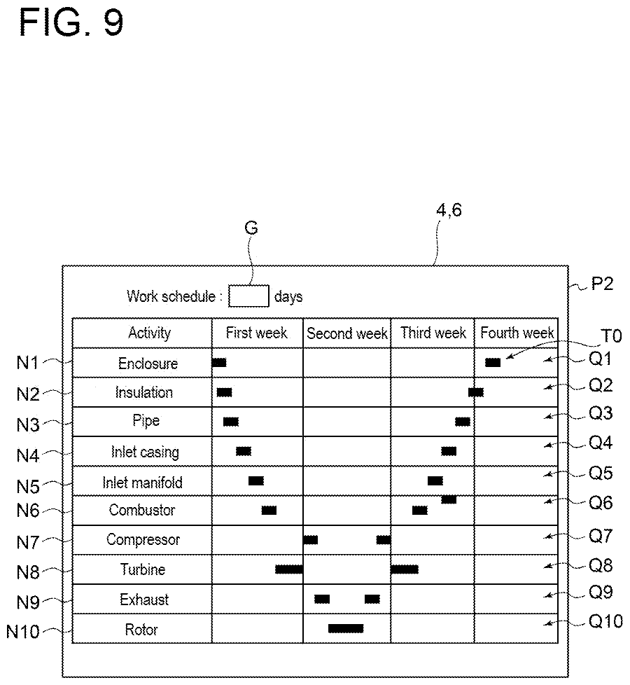

As shown in FIG. 6, in S101, the display control unit 14 executes the standard schedule display mode of displaying a work schedule creation menu P2 (see FIG. 9) including a standard work schedule T0 on the display unit 4. The standard work schedule T0 includes the items N1 to N10 of the plurality of work places where the work is performed in periodic inspection of the plant and work periods Q1 to Q10 by work place. Moreover, the screen of the work schedule creation menu P2 displays, in addition to the standard work schedule T0, a required period input field G for inputting the required period (for example, the required days) for the periodic inspection in the work schedule. In the illustrated example, as the items N1 to N10 of the work places, the enclosure, the insulation, the pipe, the inlet casing, the inlet manifold, the combustor, the compressor, the turbine, the exhaust, and the rotor are shown, respectively, and regarding a series of works from disassembling to reassembling of the gas turbine, a work period for each work place is shown by using a bar chart. In the standard schedule display mode, display contents are complicated by completely displaying the work period for each work place in detail, which makes it difficult to grasp the work schedule. Thus, displaying the work period for each work place by extracting only a critical path, it is possible to easily grasp the work schedule.

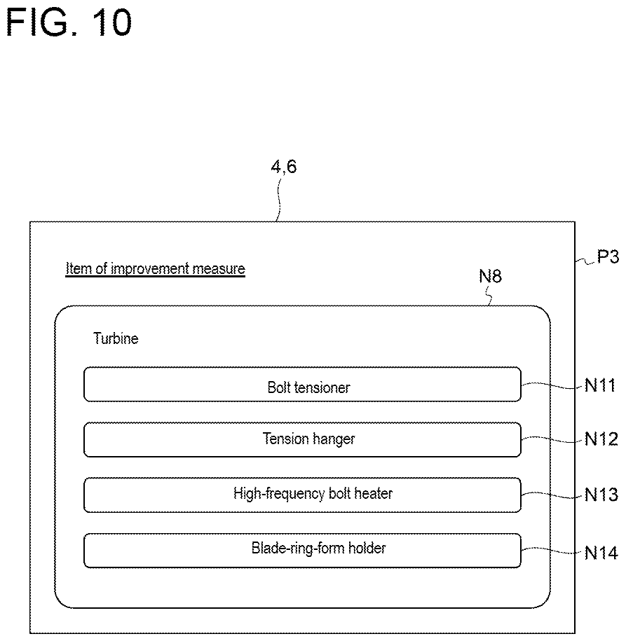

S102 includes determining contents input from the input unit 6 during execution of the standard schedule display mode. If the input unit 6 selects any one of the items N1 to N10 of the work places during execution of the standard schedule display mode, the display control unit 14 executes the improvement measure by work place display mode in S103. As shown in FIG. 10, in the improvement measure by work place display mode, regarding the work place selected during execution of the standard schedule display mode, an improvement measure item menu P3 which includes the items N1 to N14 of the plurality of improvement measures capable of improving the work performed in periodic inspection of the plant is displayed on the display unit 4. For example, if the item N8 is selected during execution of the standard schedule display mode, regarding the work place indicated by the item N8, the items N11 to N14 of the plurality of improvement measures capable of improving the work performed in periodic inspection of the plant is displayed on the display unit 4. The improvement measure may be, for example, an object such as a tool capable of improving the work or may be, for example, review work and adjustment work of alignment relaxation and the like. In the illustrated example, as the improvement measures capable of improving the work performed in inspection of the item N8 of the turbine, the item N11 of the bolt tensioner, the item N12 of the tension hanger, the item N13 of the high-frequency bolt heater, the item N14 of the blade-ring-form holder are shown, respectively.

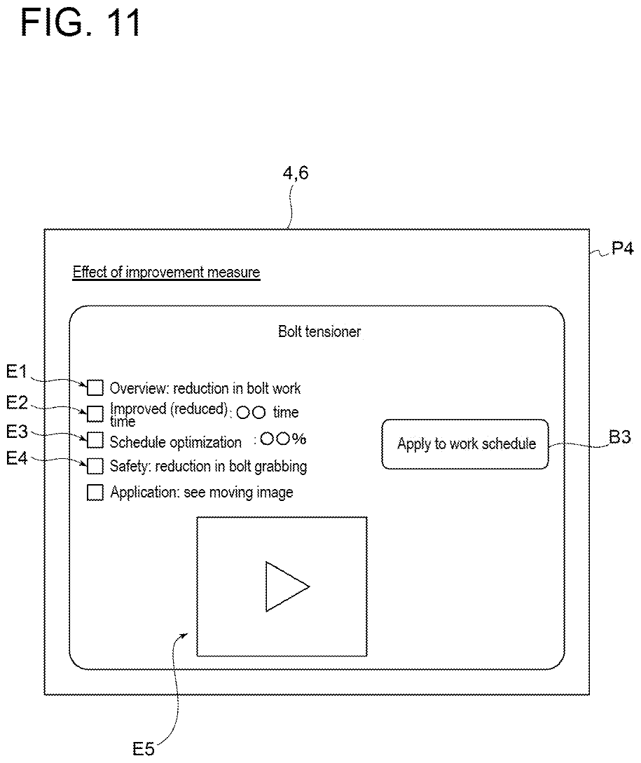

Next, in S104, if the input unit 6 selects any one of the items of the improvement measures from among the items N11 to N14 of the plurality of improvement measures displayed in the improvement measure by work place display mode, the display control unit 14 executes the improvement effect display mode in S105. As shown in FIG. 11, in the improvement effect display mode, regarding the item selected in S104, the details of the improvement measure including the effects E1 to E4 of the improvement measure are displayed on the display unit 4. The effects of the improvement measure here may include the overview E1 of the effect of the improvement measure, the shortening effect E2 of the required period for work (for example, the reduced time of work by the improvement measure), the percentage E3 of schedule optimization, and the improvement effect E4 of safety, as shown in FIG. 11, for example. Further, in the improvement effect display mode, in addition to the effects E1 to E4 of the improvement measure, a moving image E5 showing the contents of the improvement measure, a cost required to introduce the improvement measure, and the like may be displayable on the display unit 4. Furthermore, as shown in FIG. 11, a screen P4 of the improvement effect display mode displays an application button B3 for applying the improvement measure selected in S104 to the work schedule. In the illustrated example, the improvement effects E1 to E4 in the case where the bolt tensioner is selected as the improvement measure in S104 are shown. The above-described moving image E5 may be a PR moving image of, for example, a product, a jig and tool, or the like related to the improvement measure. Thus, it is possible to reduce an effort to explain the product, the jig and tool, or the like.

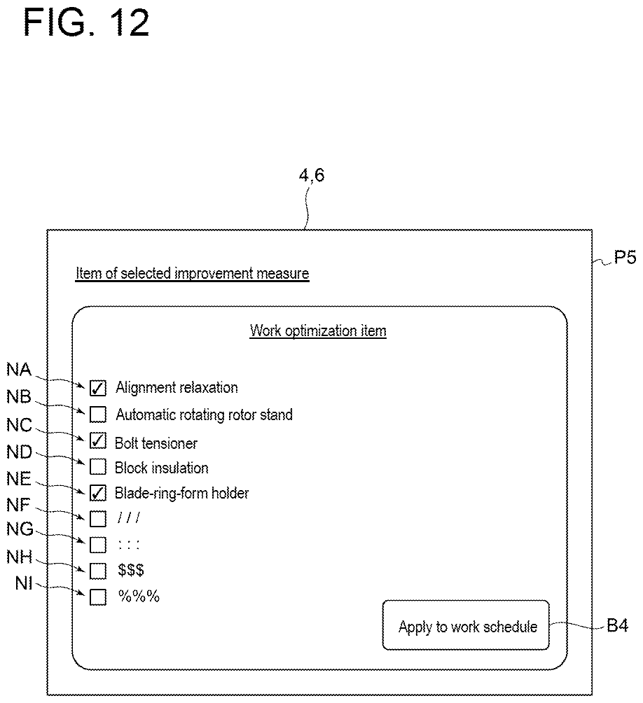

If the input unit 6 selects the application button B3 in S106 during execution of the improvement measure effect display mode, the display control unit 14 executes the selected improvement measure display mode in S107. As shown in FIG. 12, in the selected improvement measure display mode, items NA to NI of a plurality of improvement measures are listed on the display unit 4, and items NA, NC, NE of selected improvement measures selected by the input unit 6 are highlighted. In the example of the display screen of the display unit 4 shown in FIG. 12, a check box is displayed on the left side of each of the items NA to N1 of the plurality of improvement measures, and a check mark as the highlight is placed in the check box on the left side of each of the items NA, NC, NE of the selected improvement measures. Further, the display control unit 14 is configured to be able to change the presence or absence of the highlight with respect to the item of the improvement measure in accordance with the operation of the input unit 6, in the selected improvement measure display mode. Furthermore, as shown in FIG. 12, a screen P5 of the selected improvement measure display mode displays an application button B4 for applying the items NA, NC, NE of the selected improvement measures displayed on the screen P5 to the work schedule.

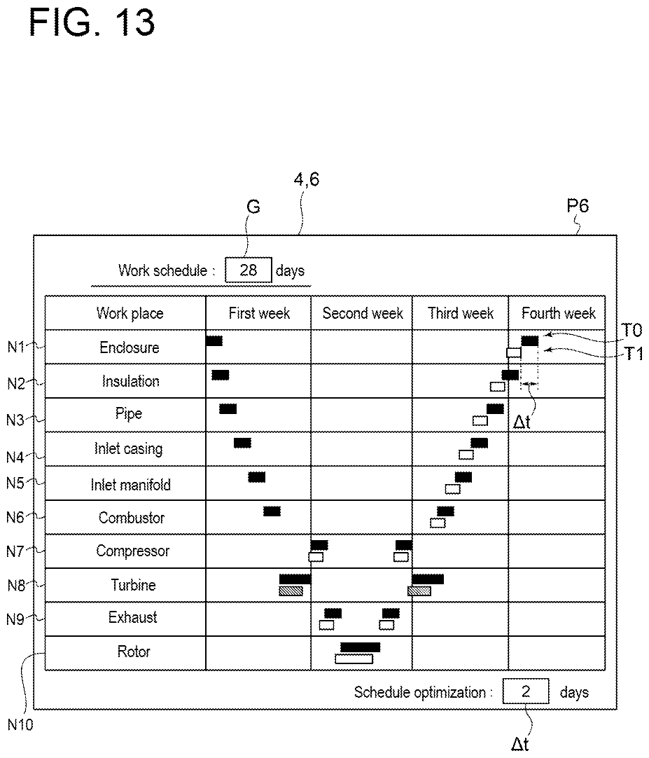

If the input unit 6 selects the application button B4 in S108, in S109, the improved schedule creation unit 16 creates an improved work schedule TI obtained by improving the standard work schedule T0. In S109, the improved schedule creation unit 16 creates the improved work schedule T1 based on the standard work schedule T0 and shortening effect information indicating a shortening effect of the required period for work by application of the improvement measure in the item selected by the input unit 6 from among the items of the plurality of improvement measures (for example, information indicating the above-described shortening effect E2). Then, the display control unit 14 executes the improved schedule display mode of displaying the improved work schedule T1 created by the improved schedule creation unit 16 on the display unit 4. In the example shown in FIG. 13, the display control unit 14 displays the improved work schedule T1 created by the improved schedule creation unit 16 and the standard work schedule T0 side by side for comparison on the display unit 4 in the improved schedule display mode.

Moreover, as shown in FIG. 13, the display control unit 14 may display, on the display unit 4, days Δt of schedule optimization (a shortening effect of a required period for periodic inspection by the improved work schedule, relative to a required period for periodic inspection in the standard work schedule), in the improved schedule display mode. On a screen P6 of the improved schedule display mode shown in FIG. 13, each black bar chart indicates the standard work schedule, each hatched bar chart (chart indicating the work period of the turbine) indicates a portion of the improved work schedule where the required period for work can be shortened relative to the standard work schedule, and each while bar chart indicates a portion of the improved work schedule where work is accelerated by an influence of the above-described portion where the required period can be shortened.

In other embodiments, the display unit 4 may display the plurality of kinds of bar charts with color coding, or may display the work schedule by a display method other than the bar charts. In the improved schedule display mode, the display contents are complicated by completely displaying the work period for each work place in detail, which makes it difficult to grasp the work schedule. Thus, displaying each work period by extracting only the critical path, it is possible to easily grasp the work schedule.

If the input unit 6 inputs the required period for the periodic inspection in the required period input field G in S102, in S110, the standard schedule correction unit 18 corrects the standard work schedule based on the required period for the periodic inspection input in S102 and the required period for the periodic inspection in the standard work schedule T0. Then, the display control unit 14 displays the corrected standard work schedule on the display unit 4. In S110, for example, provided that t0 is a required period for the periodic inspection in the standard work schedule before the standard schedule correction unit 18 performs correction, and t1 is a required period for the periodic inspection input in S102, the standard schedule correction unit 18 corrects the required period for the periodic inspection in the standard work schedule from t0 to t1, and performs percentage correction where the required period for each work of the periodic inspection is multiplied by t1/t0 for decompression or compression. Then, in S111, the display control unit 14 displays, on the display unit 4, a questionnaire sheet or the like for hanging it on contents to be proposed to the user of the plant or a further improvement in the present system.

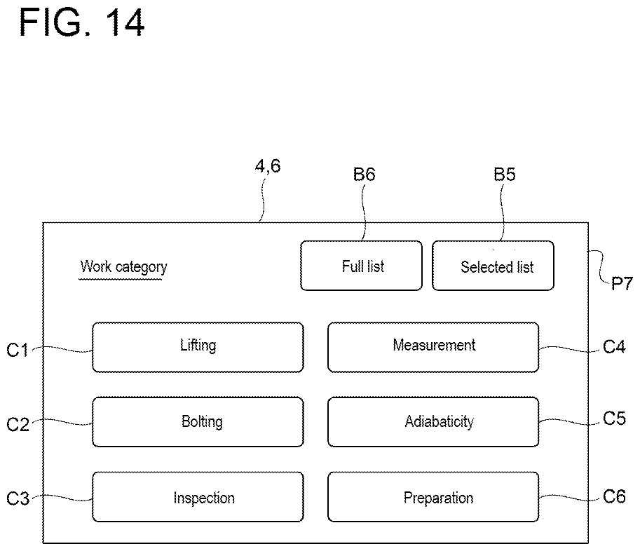

On the other hand, if the button B2 for the work category selection menu is selected in S11 of FIG. 5, as shown in FIG. 7, the display control unit 14 executes the work category display mode in S201. As shown in FIG. 14, the display control unit 14 displays, on the display unit 4, a work category selection menu P7 which includes the plurality of work categories C1 to C6 of the work performed in periodic inspection of the plant, in the work category display mode. In the illustrated example, the above-described plurality of work categories, respectively, include the lifting category C1, the bolting category C2, the inspection category C3, the measurement category C4, the adiabaticity category C5, and the preparation category C6. Moreover, a screen of the work category selection menu P7 displays a selected list button B5 for listing the items of the selected improvement measures shown in FIG. 12 and a full list button B6 for listing the items of the all improvement measures capable of improving the work performed in the periodic inspection.

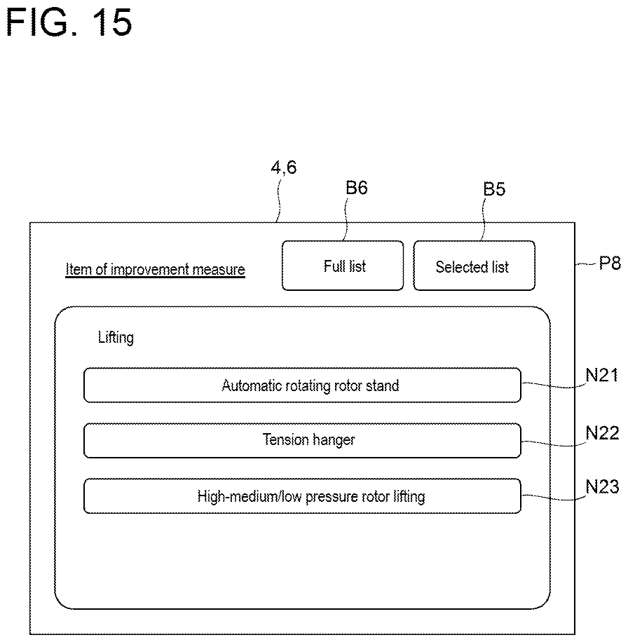

S202 includes determining contents input from the input unit 6 during execution of the work category display mode. If the input unit 6 selects any one of the work categories CI to C6 during execution of the work category display mode, the display control unit 14 executes the improvement measure by work category display mode in S203. As shown in FIG. 15, in the improvement measure by work category display mode, regarding the work category selected during execution of the work category display mode, an improvement measure item menu P8 which includes the items N21 to N23 of the plurality of improvement measures capable of improving the work performed in periodic inspection of the plant is displayed on the display unit 4. In the illustrated example, as the plurality of improvement measures for the work item C1 of lifting, the items N21 of the automatic rotating rotor stand, the item N22 of the tension hanger, and the item N23 of the high-medium/low pressure rotor lifting are displayed, respectively. Moreover, a screen of the improvement measure item menu P8 displays the selected list button B5 for listing the items of the selected improvement measures shown in FIG. 12 and the full list button B6 for listing the items of the all improvement measures capable of improving the work performed in the periodic inspection.

Next, in S204, if the input unit 6 selects any one of the items of the improvement measures from among the items N21 to N23 of the plurality of improvement measures displayed in the improvement measure by work category display mode, the display control unit 14 executes the improvement effect display mode in S205. In the improvement effect display mode, regarding the item selected in S204, the details of the improvement measure including the effect of the improvement measure are displayed on the display unit 4. The contents displayed in the improvement effect display mode are the same as those in the improvement effect display mode described with reference to FIG. 11, and thus the description thereof will be omitted.

On the other hand, if the input unit 6 selects the selected list button B5 on the screen of the work category display mode (the screen of the work category selection menu P7) shown in FIG. 14, the display control unit 14 executes the selected improvement measure display mode in S206. The processes of S206, S207, S208 are, respectively, the same as the processes of S107, S108, S109 described above, and thus the description thereof will be omitted.

Moreover, if the input unit 6 selects the full list button B6 on the screen of the work category display mode shown in FIG. 14, in S209, the display control unit 14 executes the all improvement measures display mode of listing, on the display unit 4, the items of the all improvement measures capable of improving the work performed in the periodic inspection.

According to the portable information terminal 2 serving as the work schedule creation system show above, the user of the portable information terminal 2 can visually check the improved work schedule, on which the shortening effect of the required period for the work by application of the improvement measure in the item selected by the input unit 6 is reflected, via the display unit 4 in a timely way. Thus, it is possible to examine whether to apply the improvement measure while considering a quantitative influence of the improvement measure on the work schedule of the periodic inspection. Therefore, it is possible to support selection of the appropriate improvement measure in consideration of the influence on the work schedule of periodic inspection of the plant.

Further, displaying a cost required for introduction of the improvement measure on the display unit 4 together with the effect of the improvement measure, it is possible to support selection of the improvement measure in consideration of cost-effectiveness.

Furthermore, displaying not only the object such as the jig and tool but also review work, adjustment work, and the like of tolerance relaxation and the like as the improvement measures in the improvement measure display mode, it is possible to comprehensively determine the value of these improvement measures in consideration of the shortening effect of the required period for the periodic inspection. Thus, it is possible to expect an expansion effect of the objects or works related to various improvement measures.

Moreover, contributing to the improvement in work of periodic inspection of the plant, it is possible to reduce a burden on the worker for inspection, and to solve or reduce a problem, such as shortage of workers.

Further, in the improvement measure by work place display mode, the items of the plurality of improvement measures are completely extracted to be visualized, regarding the work place selected by the input unit 6. Thus, compared to a case where a consultant is in charge of from extraction to proposal of the improvement measure, the user can completely examine whether to apply the improvement measure for each work place while reducing dependency on the ability of the person. In addition, it is possible to cut labor costs such as consultant fees.

Further, in the improvement measure by work category display mode, the items of the plurality of improvement measures are visualized, regarding the work category selected by the input unit 6. Thus, compared to the case where the consultant is in charge of from extraction to proposal of the improvement measure, the user can completely examine whether to apply the improvement measure for each work category while reducing dependency on the ability of the person.

Further, in the improvement effect display mode, since the effect of the improvement measure selected by the input unit 6 is visualized, the user can examine whether to apply the improvement measure in consideration of the effect of the improvement measure displayed on the display unit while reducing dependency on knowledge of the consultant or the like about the effect of the improvement measure.

Further, in the improved schedule display mode, the standard work schedule and the improved work schedule are displayed side by side on the display unit 4, making it easier to visually confirm a difference between the standard work schedule and the improved work schedule which is made by application of the improvement measure. Therefore, it is possible to effectively support selection of the appropriate improvement measure in consideration of the influence on the work schedule of periodic inspection of the plant.

Moreover, an actual required period for periodic inspection of the plant differs from user to user of the plant and often does not coincide with an initial value of the required period for the periodic inspection in the standard work schedule. In this regard, according to the above-described portable information terminal 2, the standard schedule correction unit corrects, based on the required period for the periodic inspection input from the input unit 6, the standard work schedule to be compressed or decompressed in accordance with the user. Thus, it is possible to create and display the appropriate improved work schedule suitable for an actual situation of the user based on the corrected standard work schedule. Therefore, it is possible to effectively support selection of the appropriate improvement measure in consideration of the influence on the work schedule of periodic inspection of the plant.

Further, in the selected improvement measure display mode, the item of the selected improvement measure is highlighted, allowing the user to easily grasp the selected improvement measure. Thus, for example, in the case where the plurality of improvement measures are selected, it is possible to easily consider the influence of the selected improvement measures on the work schedule of the periodic inspection. Therefore, it is possible to effectively support selection of the appropriate improvement measure in consideration of the influence on the work schedule of periodic inspection of the plant.

Further, in the selected improvement measure display mode, the presence or absence of the highlight for the item of the improvement measure can be changed in accordance with the operation of the input unit 6, allowing the user to easily grasp the selected improvement measure. Thus, for example, in the case where the plurality of improvement measures are selected, it is possible to easily consider the influence of the selected improvement measures on the work schedule of the periodic inspection. Therefore, it is possible to effectively support selection of the appropriate improvement measure in consideration of the influence on the work schedule of periodic inspection of the plant.

The present invention is not limited to the above-described embodiments, and also includes an embodiment obtained by modifying the above-described embodiments and an embodiment obtained by combining these embodiments as appropriate.

### REFERENCE SIGNS LIST

2 Portable information terminal
4 Display unit
6 Input limit
8 Control unit
Storage unit
12 Bus
14 Display control unit
16 Improved schedule creation unit
18 Standard schedule correction unit

1. A work schedule creation system for creating a work schedule showing a schedule of a plurality of works performed in inspection of a plant, the system comprising:
an input unit, a display unit, and a control unit,
the control unit including:
a display control unit configured to be able to execute an improvement measure display mode of displaying items of a plurality of improvement measures capable of improving the works on the display unit; and
an improved schedule creation unit configured to create, based on a standard work schedule and shortening effect information indicating a shortening effect of a required period for the works by application of an improvement measure in an item selected by the input unit from among the items of the plurality of improvement measures, an improved work schedule obtained by improving the standard work schedule,
wherein the display control unit is configured to be able to execute an improved schedule display mode of displaying the improved work schedule created by the improved schedule creation unit on the display unit.

2. The work schedule creation system according to claim 1,
wherein each of the standard work schedule and the improved work schedule includes items of a plurality of work places where the works are performed in the inspection and a work period for each of the work places.

3. The work schedule creation system according to claim 2,
wherein the display control unit is configured to be able to execute a standard schedule display mode of displaying the standard work schedule, and
wherein the display control unit is configured to display the items of the plurality of improvement measures on the display unit in the improvement measure display mode, regarding the work place selected by the input unit from among the plurality of work places during execution of the standard schedule display mode.

4. The work schedule creation system according to claim 1,
wherein the display control unit is configured to be able to execute a work category display mode of displaying a plurality of work categories of the works performed in the inspection on the display unit, and
wherein the display control unit is configured to display the items of the plurality of improvement measures on the display unit in the improvement measure display mode, regarding the work category selected by the input unit during execution of the work category display mode.

5. The work schedule creation system according to claim 1,
wherein the display control unit is configured to be able to execute an improvement effect display mode of displaying an effect of the improvement measure on the display unit, regarding the item selected by the input unit from among the items of the plurality of improvement measures displayed in the improvement measure display mode.

6. The work schedule creation system according to claim 5,
wherein the display control unit is configured to be able to display, in addition to the effect of the improvement measure, a moving image showing contents of the improvement measure on the display unit in the improvement effect display mode.

7. The work schedule creation system according to claim 1,
wherein the display control unit is configured to display the improved work schedule created by the improved schedule creation unit and the standard work schedule side by side on the display unit in the improved schedule display mode.

8. The work schedule creation system according to claim 1,
wherein the control unit includes a standard schedule correction unit configured to correct the standard work schedule based on a required period for the inspection input from the input unit and a required period for the inspection in the standard work schedule.

9. The work schedule creation system according to claim 1,
wherein the display control unit is configured to be able to execute a selected improvement measure display mode of displaying the items of the plurality of improvement measures, as well as highlighting the item of the selected improvement measure selected by the input imit.

10. The work schedule creation system according to claim 9,
wherein the display control unit is configured to be able to change presence or absence of the highlight with respect to the item of the improvement measure in accordance with an operation of the input unit in the selected improvement measure display mode.

11. A work schedule creation method for creating a work schedule showing a schedule of a plurality of works performed in inspection of a plant, the method comprising:
a step of displaying items of a plurality of improvement measures capable of improving the works on a display unit;
a step of creating, based on a standard work schedule and shortening effect information indicating a shortening effect of a required period for the works by introduction of an improvement measure of an item selected by an input unit from among the items of the plurality of improvement measures, an improved work schedule obtained by improving the standard work schedule; and
a step of displaying the improved work schedule on the display unit.
